(19) United States
(12) Patent Application Publication
(10) Pub. No.: US 2026/0121080 A1
(43) Pub. Date: Apr. 30, 2026

(54) HIGH-TEMPERATURE SOLID-STATE LITHIUM ALLOY-CARBON DIOXIDE BATTERY

(71) Applicant: Talos Tech LLC, New Castle, DE (US)

(72) Inventor: Hansan Liu, Hockessin, DE (US)

(21) Appl. No.: 18/931,774

(22) Filed: Oct. 30, 2024

(51) Int. Cl. H01M 4/90; B64G 1/42; H01M 4/40; H01M 4/86; H01M 12/02; H01M 12/08

(52) U.S. Cl. CPC H01M 4/9033; H01M 4/405; H01M 4/8605; H01M 4/8657; H01M 4/8673; H01M 12/02; H01M 12/08; B64G 1/425; H01M 2300/0074; H01M 2300/0094

(57) ABSTRACT

A high temperature solid-state lithium alloy-carbon dioxide electrochemical cell includes: a negative electrode containing a lithium alloy having a melting point greater than 500° C.; a carbon dioxide electrode including a catalyst effective to reduce carbon dioxide at a temperature of 300° C. to 600° C. during discharge of the electrochemical cell; and a solid electrolyte including an oxide solid electrolyte and having a dense layer that separates the negative electrode and the carbon dioxide electrode, the dense layer having a porosity of less than 2 percent based on a total volume of the dense layer. A method of using the cell or a stack thereof includes exposing the cell or a stack thereof to an ambient environment which includes a carbon dioxide gas having a temperature of 300° C. to 600° C. and a pressure of 1 atm to 100 atm.

### GOVERNMENT SUPPORT

This invention was made with government support under Contract No. 80NSSC22CA076 awarded by The National Aeronautics and Space Administration. The Government has certain rights in the invention.

### BACKGROUND

The disclosure generally relates to lithium-carbon dioxide batteries, in particular to high-temperature solid-state lithium alloy-carbon dioxide batteries.

The planet Venus is an interesting target for scientific exploration. However, despite being a close neighboring planet to Earth, Venus is relatively under-explored due to its hostile and extreme environment. Unlike Earth, Venus has a very dense atmosphere composed mostly of carbon dioxide. The dense atmosphere creates a runaway green-house effect making Venus the hottest planet in the solar system with a surface temperature of 390 to 485° C. and a surface pressure of 92 bar.

The challenging surface conditions present a significant challenge to the power system of the spacecraft and equipment for carrying out extended operations on the Venus surface. Conventional power technologies, such as photovoltaic power systems and the traditional batteries, which are designed mainly for Earth temperature applications, could not survive on Venus surface for a meaningful amount of time to meet the requirements of Venus surface missions. Therefore, there is a continuing need for batteries that can be used in a high temperature carbon dioxide environment. It would be a further advantage if the battery is durable under extreme high-temperature and high-pressure conditions, allowing it to support extended operations on Venus surface.

### SUMMARY

A high temperature solid-state lithium alloy-carbon dioxide electrochemical cell includes: a negative electrode containing a lithium alloy having a melting point greater than 500° C.; a carbon dioxide electrode including a catalyst effective to reduce carbon dioxide at a temperature of 300° C. to 600° C. during discharge of the electrochemical cell; and a solid electrolyte including an oxide solid electrolyte and having a dense layer that separates the negative electrode and the carbon dioxide electrode, the dense layer having a porosity of less than 2 percent based on a total volume of the dense layer.

A device includes at least one of the above-described high temperature solid-state lithium alloy-carbon dioxide electrochemical cell or a stack thereof.

A method includes providing the above-described high temperature solid-state lithium alloy-carbon dioxide electrochemical cell or a stack thereof, and contacting the solid-state lithium alloy-carbon dioxide electrochemical cell or the stack thereof with a carbon dioxide gas having a temperature of 300° C. to 600° C.

Another method includes providing the above-described high temperature solid-state lithium alloy-carbon dioxide electrochemical cell or a stack thereof, and exposing the solid-state lithium alloy-carbon dioxide electrochemical cell or the stack thereof to an ambient environment which includes a carbon dioxide gas having a temperature of 300° C. to 600° C. and a pressure of 1 atm to 100 atm.

### BRIEF DESCRIPTION OF THE DRAWINGS

The following description should not be considered limiting in any way. With reference to the accompanying drawings, like elements are numbered alike:

FIG. 1 is a simplified diagram of an embodiment of a high temperature solid-state lithium alloy-carbon dioxide (Li alloy-CO₂) electrochemical cell where the solid electrolyte has a mono-layer structure;

FIG. 2 is a simplified diagram of an embodiment of a high temperature solid-state Li alloy-CO₂ electrochemical cell where the solid electrolyte has a bi-layer structure;

FIG. 3 is a simplified diagram of an embodiment of a high temperature solid-state Li alloy-CO₂ electrochemical cell where the solid electrolyte has a tri-layer structure;

FIG. 4 is a diagram of an embodiment of a single electrochemical cell of the disclosure;

FIG. 5 is a diagram of a stack of the electrochemical cell of FIG. 4;

FIG. 6 is a graph of theoretical voltage (volts, v) as a function of theoretical specific capacity (milliampere-hours per gram, mAh/g) of a conventional Li—CO₂ electrochemical cell, a lithium-oxygen (Li—O₂) electrochemical cell, and a high temperature solid-state Li—CO₂ electrochemical cell according to the disclosure;

FIG. 7A and FIG. 7B are graphs of cell voltage (V) versus capacity (mAh) of the Cell Example 1 during discharge (7A) and charge (7B) at 500° C.;

FIG. 8 is a graph of cell voltage (V) versus areal capacity (milliampere-hours per square centimeter of the CO₂ electrode, mAh/cm²) of Cell Example 3 during charge and discharge at different currents and 500° C.;

FIG. 9 is a graph of cell voltage (V) versus time (hour) of Cell Example 3 during discharge at 500° C.;

FIG. 10 is a graph comparing the areal capacity (mAh/cm²) of Cell Example 3 with the reported areal capacities of a commercial Li ion battery, a molten salt Li—CO₂ battery, a molten salt Li—O₂ battery, and a solid-state Li-air battery;

FIG. 11 is a graph of cell voltage (V) versus areal capacity (mAh/cm²) of Cell Example 4 during charge and discharge at 500° C.;

FIG. 12 is a graph of cell voltage (V) versus areal capacity (mAh/cm²) of Cell Example 5 during charge and discharge at 500° C.;

FIG. 13 is a side view of a 4-cell stack 1; and

FIG. 14 is a side view of a 8-cell stack 2.

### DETAILED DESCRIPTION

The inventor has discovered an electrochemical cell that is durable and safe to use at a high temperature such as 300-600° C. in the presence of CO₂. Advantageously, even at the high temperature, the electrochemical cell can have low self-discharge and high energy density. Moreover, the electrochemical cell utilizes CO₂ as a reactant and has a novel electrochemical reaction pathway at a high temperature, which enables the cell to deliver a high areal capacity (e.g., at least 25 mAh/cm²). The electrochemical cell of the disclosure can be particularly suitable for use in Venus surface missions as high temperature CO₂ is readily available as the ambient gas on Venus surface.

The high temperature solid-state Li alloy-CO₂ electrochemical cell of the disclosure has a negative electrode comprising a lithium alloy, a CO₂ electrode comprising a catalyst effective to reduce CO₂ at a temperature of 300 to 600° C. during discharge of the electrochemical cell, and a solid electrolyte having a dense layer that separates the negative electrode and the CO₂ electrode. On discharge, the CO₂ electrode may be a positive electrode.

As used herein, the term “dense layer” means a layer having a porosity of less than 2%, or less than 1%, or less than 0.5%, based on a total volume of the dense layer. In the context of the solid electrolyte, the term “dense layer” is used interchangeably with the term “dense solid electrolyte layer.” Accordingly, a dense layer also refers to a dense solid electrolyte layer having a porosity of less than 2%, or less than 1%, or less than 0.5%, based on a total volume of the dense solid electrolyte layer, e.g., 0.001 to 2%, 0.01 to 1%, or 0.1 to 0.5%, based on a total volume of the dense solid electrolyte layer. Preferably, the pores in the dense layer, if present, are not connected to form a pathway between the opposing surfaces of the dense layer. Thus, the dense layer can have a porosity or tortuosity suitable to prevent the crossover of gases (e.g., CO₂) and/or liquids (e.g., liquid lithium if present).

Unless indicated otherwise, a “high temperature” means a temperature of greater than 300° C., for example 300° C. to 600° C.

### Negative Electrode

Unlike a Li—CO₂ battery using pure lithium as a negative electrode, the high temperature solid-state electrochemical cell of the disclosure has a negative electrode including a lithium alloy having a melting temperature greater than 500° C., for example 550° C. to 2,000° C., 600° C. to 1500° C., or 650° C. to 1300° C. Unless indicated otherwise, the melting temperature as used herein refers to the melting temperature at the standard atmosphere (1 atm).

The melting point of pure lithium is 180.5° C. In an electrochemical cell with pure lithium as the negative electrode, at an operation temperature of 300° C. to 600° C., lithium melts. The molten lithium is highly corrosive and can react with the adhesives that seal the electrochemical cell and leak, thus causing significant damage to a power system that contains the electrochemical cell. Using a lithium alloy having a melting point greater than 500° C. can significantly mitigate the problems caused by the highly reactive and corrosive molten lithium at high temperature operation conditions.

The lithium alloy in the negative electrode of the electrochemical cell of the disclosure can have a lithium content of 20 weight percent (20 wt %) to 90 wt %, or 35 wt % to 90 wt %, preferably 40 wt % to 90 wt %, or 50 wt % to 90 wt %, and more preferably 60 wt % to 85 wt %, based on a total weight of the lithium alloy. When the lithium content is within these ranges, the lithium alloy can remain in a solid state at a temperature of 300° C. to 600° C. In addition, an electrochemical cell having a negative electrode including an alloy with the disclosed lithium content can achieve low interfacial impedance between the negative electrode and the solid electrolyte (good affinity with the electrolyte at high temperature) and high specific capacity.

Examples of the lithium alloy can include lithium aluminum alloy, lithium boron alloy, lithium silicon alloy, or a combination thereof. In an aspect, the lithium alloy can be a lithium aluminum alloy, wherein a content of lithium in the alloy is 20 wt % to 50 wt %, or 20 wt % to 40 wt %, based on a total weight of the alloy. In an aspect, the lithium alloy is a lithium boron alloy, a lithium silicon alloy, or a combination thereof, where a content of lithium in the alloy is 20 wt % to 90 wt %, preferably 50 wt % to 90 wt %, and more preferably 60 wt % to 85 wt %, based on a total weight of the lithium alloy.

The inventor has discovered that using a lithium boron alloy can provide further advantageous properties. The phase diagram of lithium boron alloy shows that super high lithium content (up to 90 wt %) can be achieved for a lithium boron alloy having a melting temperature of greater than 500° C. As illustrated by the examples, using a lithium boron alloy with a lithium content of 50 wt % to 90 wt %, 60 wt % to 90 wt %, or 70 wt % to 80 wt %, the electrochemical cell can have a high specific capacity (therefore high energy density) due to the high lithium content. In addition, the affinity between the lithium alloy and the solid electrolyte can be improved, resulting in lower interfacial impedance and reduced voltage loss.

The lithium boron alloy having the disclosed lithium content can also minimize the impact of volume change of the negative electrode at high temperatures. Without wishing to be bound by theory, it is believed that when boron reacts with lithium with heating, an ionic and electronic conducting Li—B compound (Li₇B₆) is formed first as a matrix, and then free molten lithium is absorbed into the porous matrix. Because Li₇B₆ alloy has a higher discharge voltage (0.4V) than pure lithium, it is believed that only free lithium in a lithium rich LiB alloy (Li₇B₆+additional Li) would be used for electrochemical reactions. The Li₇B₆ alloy can thus serve as an inactive matrix to maintain the negative electrode shape and ionic or electronic conductivity.

Specific examples of the lithium alloys include LiAl, Li₇Al₃, Li₇B₆, Li₇B₆+15Li, Li₇B₆+31Li, Li₇B₆+78Li, LiSi, or a combination thereof.

### CO₂ Electrode

The CO₂ electrode of a high temperature solid-state electrochemical cell of the disclosure comprises a catalyst that is effective to reduce CO₂ at a temperature of 300° C. to 600° C. during discharge of the electrochemical cell. Preferably, the electrochemical cell produces carbon and lithium oxide (Li₂O) at a temperature of 300° C. to 600° C. during a discharge cycle, and produces lithium and CO₂ during a charge cycle.

Examples of the catalyst include Au, Ag, Ir, Ru, or a combination thereof. The catalyst can be present in the CO₂ electrode as nanoparticles, for example nanoparticles having an average particle size of 5 nanometers (nm) to 200 nm, 5 nm to 150 nm, or about 100 nm or 5 nm to 10 nm. As used herein, the average particle size means the number average particle size, and can be determined by laser diffraction, dynamic light scattering, or image analysis, for example with a HORIBA instrument or scanning electron microscope (SEM).

The loading of the catalyst in the CO₂ electrode can be 0.5 milligram per square centimeter of the CO₂ electrode (mg/cm²) to 20 mg/cm², preferably 1 to 10 mg/cm², and more preferably 3 to 5 mg/cm².

In addition to the catalyst, the CO₂ electrode can further include an electron conducting material, and optionally an ion conducting material, preferably a lithium ion conducting material. When the CO₂ electrode is disposed inside pores of a porous solid electrolyte layer as described herein below, the CO₂ electrode may or may not contain an ion conducting material as the solid electrolyte surrounding the CO₂ electrode has good lithium ion conductivity. For the cell where the CO₂ electrode is a standalone layer, the CO₂ electrode can contain an ionic-electronic conducting material. As used herein, an ionic-electronic conducting material refers to a compound or a combination of different compounds (e.g., a combination of both an electron conducting material and an ion conducting material) that can provide ionic conductivity and electronic conductivity.

Suitable ion conducting material and the ionic-electronic conducting material can have an ionic conductivity, preferably a lithium-ion conductivity, of at least 10 milliSiemens per centimeter (mS/cm), for example 10 mS/cm to 60 ms/cm, preferably 15 mS/cm to 55 mS/cm, or 20 mS/cm to 50 mS/cm at 25° C. Ionic conductivity can be determined by electrochemical impedance spectroscopy (EIS). Examples of the ion conducting material can include lithium lanthanum zirconium oxide and/or a lithium lanthanum zirconium oxide doped with Ta, Nb, or a combination thereof (collectively “LLZO”), an eutectic molten salt of lithium-sodium-potassium, or a combination thereof.

Examples of the electron conducting material include carbon nanotube, silver paste, silver foam, lithium cobalt oxide (LCO), lanthanum strontium cobalt ferrite (LSCF), or a combination thereof. LCO and LSCF are also known as mixed ionic-electronic conducting materials. A “mixed ionic-electronic conducting material” is a material that can simultaneous conduct both ions and electrons. As used herein, a silver foam refers to a porous foam of silver metal. The silver foam can be an open-cell foam with a porosity of 20% to 80%, preferably 40% to 60%, based on a total volume of the foam.

When the CO₂ electrode is a standalone layer, a content of the ionic-electronic conducting material can be 70 wt % to 98 wt %, preferably 75% to 95%, and more preferably 80% to 90%, based on a total weight of the catalyst and the ionic-electronic conducting material.

When the CO₂ electrode is disposed within the pores of a porous solid electrolyte layer, a content of the electron conducting material can be 0% to 80%, preferably 20% to 60%, and more preferably 30% to 50%, based on a total weight of the catalyst and the electron conducting material. It is noted that the catalyst nanoparticles can be supported on carbon nanotubes. In addition, the catalyst itself, if used at a higher amount, can also serve as an electron conducting material.

The CO₂ electrode can have a porosity of 40% to 80%, 40% to 70%, or 40% to 60%, based on a total volume of the CO₂ electrode. The CO₂ electrode can be configured to contact a CO₂-containing gas having a temperature of 300° C. to 600° C., preferably 350° C. to 550° C., and more preferably 400° C. to 500° C. In the pores of the CO₂ electrode, there can be a CO₂ gas having a temperature of 300° C. to 600° C., preferably 350° C. to 550° C., and more preferably 400° C. to 500° C. The CO₂ gas can comprise greater than 90 weight percent (wt %), greater than 92 wt %, or greater than 95 wt % of CO₂, based on a total weight of the CO₂ gas.

### Solid Electrolyte

The solid electrolyte of the high temperature solid-state electrochemical cell of the disclosure comprises an oxide solid electrolyte (also referred to as “Oxide SE”).

The oxide solid electrolyte can have a garnet structure. Preferably, the oxide solid electrolyte has a composition represented by Formula I: Li₅₊ₓLa₃ZrₓM₂₋ₓO₁₂ (Formula I), wherein x is 1.5 to 2, and M is Ta, Nb, or a combination thereof. One specific example of the oxide solid electrolyte is Li_{6.4}La₃Zr_{1.4}Ta_{0.6}O₁₂. The oxide solid electrode can have a lower than desirable conductivity at Earth's room temperature. To improve the conductivity, for room temperature applications, liquid electrolytes, polymer electrolytes or gel type electrolytes are often used together with oxide solid electrolytes. Although liquid, polymer, and/or gel type electrolytes can be helpful for room temperature applications, they can be problematic for extraterrestrial or high temperature applications. The inventor has found that at high temperatures, even without the liquid, gel, or polymer electrolytes, the oxide solid electrolyte as described herein (preferably a garnet type, more preferably an oxide of Formula I) can have good bulk lithium ion conductivity. For example, the oxide solid electrolyte as described herein can have an ionic conductivity of greater than 0.1 S/cm, for example 0.1 S/cm to 0.5 S/cm, or 0.3 to 0.5 S/cm at 500° C. In addition to high conductivity, the oxide-based electrolyte (preferably a garnet type, and more preferably the oxide of Formula I) can have good wettability with the lithium alloy as described herein, which allows for reduced interfacial resistance and improved capacity. The oxide solid electrolyte can also show a high chemical stability against metallic lithium, and a high electrochemical window above 5 volts. Preferably the solid electrolyte is free of a liquid electrolyte, a gel electrolyte, and/or a polymer electrolyte.

As discussed herein, the solid electrolyte has a dense layer that separates the negative electrode and the CO₂ electrode. In particular, the dense layer has a very limited porosity as defined herein, and the pores are not connected thus the dense layer can substantively prevent or prevent the crossover of CO₂ and liquid lithium if present. The dense layer can have an ionic conductivity (e.g. lithium ion conductivity) of greater than 40 mS/cm at 500° C. With high lithium ion conductivity and substantial or complete separation of the negative electrode and the CO₂ electrode, the electrochemical cell can have significantly decreased self-discharging and increased coulombic efficiency.

The solid electrolyte can have a mono-layer structure, a bi-layer structure, or a tri-layer structure. For the mono-layer structure, the solid electrolyte only has the dense layer. The dense layer can have a thickness of 100 microns (μm) to 1,500 μm, or 100 μm to 1,000 μm, or 100 μm to 500 μm.

The dense layer can be prepared by first pressing a powder of the oxide solid electrolyte as described herein into pellets using a die. The pellets can have an average thickness of less than 1,500 μm, for example greater than 1,000 μm to 1,500 μm or 500 μm to 800 μm. The pellets can then be sintered at a temperature of 800° C. to 1,500° C., preferably 900° C. to 1,300° C., or 900° C. to 1,200° C. to form the dense solid electrolyte layer. The pressing and sintering can be a two-step or one-step process. Other known methods to prepare a solid electrolyte layer consisting of a dense layer can also be used.

When the solid electrolyte has a mono-layer (dense layer) structure, the negative electrode comprises a layer of the lithium alloy and is disposed on a first surface of the dense solid electrolyte layer. The negative electrode can have a thickness of 75 μm to 1,000 μm, preferably 100 μm to 750 μm, and more preferably 200 μm to 500 μm.

The lithium alloy layer can be made by pressing lithium alloy powder, or other art-standard techniques. For example, lithium alloy power can be pressed into pellets using a die press and form into the negative electrode after heating. The negative electrode can then be disposed onto the dense solid electrolyte layer. To further improve the wettability of the lithium alloy, a layer of lithium metal having a thickness of less than 50 μm (e.g., 2-45 μm) can be disposed between the dense solid electrolyte layer and the negative electrode.

A negative electrode current collector can be optionally disposed on (e.g., in direct contact with) the negative electrode, opposite the dense solid electrolyte layer. The negative electrode current collector may comprise any suitable metal or alloy, and may include iron, nickel, copper, stainless steel, or a combination thereof. The negative current collector can have a thickness of 25 μm to 50 μm for foils, or 500 μm to 1,000 μm for foams.

The CO₂ electrode can be a layer comprising the catalyst as described herein, and an ionic-electronic conducting material and is disposed on a second surface of the dense solid electrolyte layer, and the second surface is opposite the first surface where the negative electrode is disposed on. The ionic-electronic conducting material can comprise lithium lanthanum zirconium oxide; a lithium lanthanum zirconium oxide doped with Ta, Nb, or a combination thereof; lithium cobalt oxide; lanthanum strontium cobalt ferrite; an eutectic molten salt of lithium-sodium-potassium; carbon nanotube; silver foam; or a combination thereof. The CO₂ electrode can have a thickness of 100 μm to 1000 μm, preferably 200 μm to 800 μm, and more preferably 300 μm to 500 μm.

The stand-alone CO₂ electrode can be made by mixing the catalyst and the ionic-electronic conducting material and a solvent to make a paste, coating the paste onto the dense solid electrolyte layer, and heating the paste at an elevated temperature. For example, a CO₂ electrode can be fabricated by creating a paste of the catalyst and an ionic-electronic conducting material in a solvent (e.g., N-methyl-2-pyrrolidone), coating the dense layer with the paste, drying the coating to remove the solvent, and sintering under inert gas such as nitrogen.

The electrochemical cell can further include a CO₂ electrode current conductor disposed on (e.g., in direct contact with) the CO₂ electrode, opposite the dense solid electrolyte layer. Preferably, the CO₂ electrode current collector is free of carbon paper, since the Applicant has found that carbon paper may not be stable under the high temperature CO₂ operation conditions in the electrochemical cell as described herein. The CO₂ electrode current collector for the high temperature Li alloy-CO₂ electrochemical cell can comprise a gold or silver foam, or a gold or silver mesh. The current collector can have a thickness of 100 μm to 500 μm for mesh, or 500 μm to 1000 μm for foam.

For the solid electrolyte having a bi-layer structure, the solid electrolyte comprises the dense layer as described herein and a porous layer.

As used herein, a “porous layer” refers to a layer having a porosity of 40% to 80%, preferably 40% to 70%, based on a total volume of the porous layer. In the context of solid electrolyte, a “porous layer” is used interchangeably with the term a “porous solid electrolyte layer.” Accordingly, a porous layer can refer to a porous solid electrolyte layer having a porosity of 40% to 80%, preferably 40% to 70%, based on a total volume of the porous solid electrolyte layer. The porous layer can have an average pore size of 100 nm to 5,000 nm, preferably 500 nm to 1,000 nm. The porosity can be determined by mercury (Hg) intrusion porosimetry, for example as is set forth in ISO 15901-1, the entire disclosure of which is incorporated herein by reference.

For the bi-layer structure, the dense layer can have a thickness of 100 μm to 500 μm, and the porous layer can have a thickness of 500 μm to 1,000 μm. The solid electrolyte can be prepared by methods such as die pressing and slurry coating followed by sintering. For example, the bi-layer structure can be prepared by pressing oxide solid electrolyte powders to form a pressed oxide solid electrolyte layer, coating the pressed oxide solid electrolyte layer with a paste of an oxide solid electrolyte and a pore former, and sintering the assembly, for example at 800° C. to 1500° C., preferably 900° C. to 1300° C. After sintering, the pressed solid electrolyte layer becomes the dense layer, and the paste becomes the porous layer. Alternatively, a dense layer can be made separately first as described herein in the context of a mono-layer structure. A paste of an oxide solid electrolyte and a pore former can be coated on the dense layer and sintered, thereby forming a porous layer on the dense layer.

The bi-layer solid electrolyte can have a first surface on the dense layer and an opposite second surface on the porous layer. In this instance, the negative electrode can comprise a layer of the lithium alloy disposed on the first surface of the dense solid electrolyte layer, where the negative electrode can be the same as the negative electrode as described herein in the context of an electrochemical cell having a solid electrolyte layer with a mono-layer (dense layer) structure. A lithium layer with a thickness of less than 50 μm can be disposed between the negative electrode and the dense solid electrolyte layer. A negative electrode current collector as described herein can be disposed on the negative electrode opposite the dense solid electrolyte layer.

The CO₂ electrode, on the other hand, is disposed inside a plurality of pores of the porous solid electrolyte layer. The CO₂ electrode can comprise the catalyst and optionally an electron conducting material as described herein. Examples of the electron conducting material can include lithium cobalt oxide; lanthanum strontium cobalt ferrite; carbon nanotube; silver foam; or a combination thereof.

The catalyst can be mixed with the electron conducting material (if used) and a solvent to form a mixture, and the mixture is infiltrated into the pores of the porous solid electrolyte layer. Preferably, the mixture contains less than 5 wt % or less than 1 wt % of a polymeric binder or there is no polymeric binder used in electrodes. After infiltration, the CO₂ electrode can be heated at a temperature of 300° C. to 600° C. to remove the solvent, thereby forming the CO₂ electrode inside the pores of the porous solid electrolyte layer. As described herein, the porous solid electrolyte layer can have an average pore size of 100 nm to 5,000 nm, preferably 500 nm to 1,000 nm. Without wishing to be bound by theory, it is believed that when the average pore size is within these ranges, the surface contact area between the CO₂ electrode and the oxide solid electrolyte can be maximized, while still allowing for sufficient infiltration of the catalyst and the electron conducting material.

A CO₂ electrode current collector as described herein can be disposed on a surface (second surface) of the porous solid electrolyte layer, opposite the first surface on the dense layer.

The solid electrolyte can also have a tri-layer structure with a dense layer disposed between a first porous layer and a second porous layer. The first and second porous layers have the same meaning as the “porous layer” defined herein in the context of the bi-layer structure. The dense layer in the tri-layer structure can have a thickness of 100 μm to 500 μm, and the first porous layer and the second porous layer can each independently have a thickness of 500 μm to 1,000 μm and a porosity of 40% to 80%, preferably 40% to 70%, based on a total volume of the respective first porous layer or the second porous layer.

The tri-layer solid electrolyte can be fabricated by die pressing and slurry/paste coating, followed by sintering. The process of making a tri-layer solid electrolyte can be similar to the process of making a bi-layer solid electrolyte. The difference is that instead of just coating one surface of the pressed solid electrolyte layer or the dense layer with a slurry or paste of an oxide solid electrolyte and a pore former, two opposing surfaces of the pressed solid electrolyte or the dense layer are coated with an oxide solid electrolyte and a pore former in order to make the tri-layer structure.

The tri-layer solid electrolyte can have a first surface on the first porous layer, and an opposite second surface on the second porous layer, where the negative electrode is disposed inside a plurality of pores of the first porous layer, and the CO₂ electrode is disposed inside a plurality of pores of the second porous layer.

To form the negative electrode, the lithium alloy as described herein can be melted, and the liquid lithium alloy can be infiltrated into the pores of the first porous solid electrolyte layer. By disposing the lithium alloy inside the pores of the porous layer, the contact area between the lithium alloy and the oxide solid electrolyte can be increased, thus reducing the interfacial impedance. A negative electrode current collector as described herein can optionally be disposed on the first surface of the first porous layer opposite the dense layer.

The CO₂ electrode can be disposed inside a plurality of pores of the second porous solid electrolyte layer as described herein in the context of a cell having a solid electrolyte with a bi-layer structure. A CO₂ electrode current collector as described herein can optionally be disposed on the second surface of the second porous solid electrolyte layer.

### Electrochemical Cell

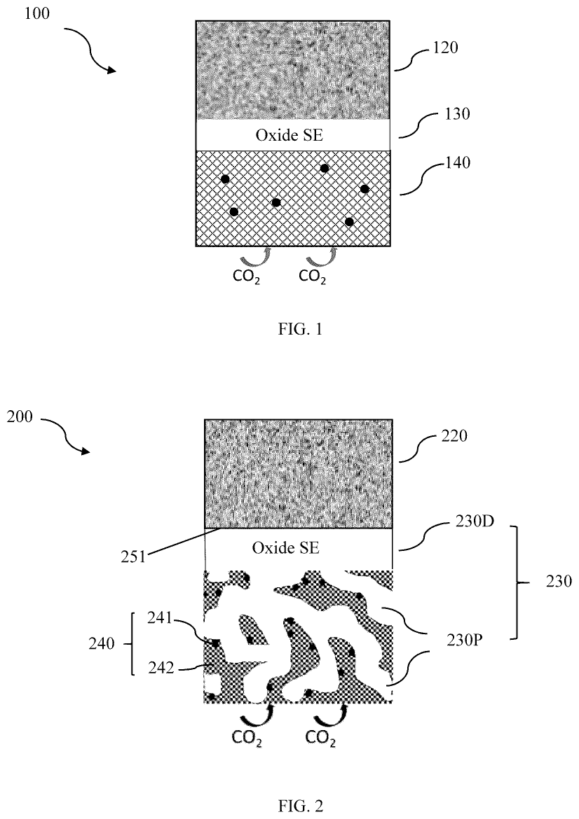

The electrochemical cell as described herein is illustrated in FIGS. 1-3. As shown in FIG. 1, an embodiment of the electrochemical cell (100) includes a negative electrode (120), a CO₂ electrode (140), and a solid electrolyte which is a dense layer (130) that separates the negative electrode (120) and the CO₂ electrode (140).

FIG. 2 illustrates a high temperature solid-state Li alloy-CO₂ electrochemical cell where the solid electrolyte has a bi-layer structure. In particular, the solid electrolyte (230) in the electrochemical cell (200) has a dense layer (230D) and a porous layer (230P). A negative electrode (220) is disposed on a surface (251) of the dense solid electrolyte layer (230D), and a CO₂ electrode (240) is disposed inside a plurality of the pores of porous layer (230P), where the CO₂ electrode (240) comprises a catalyst (241) and an electron conducting material (242).

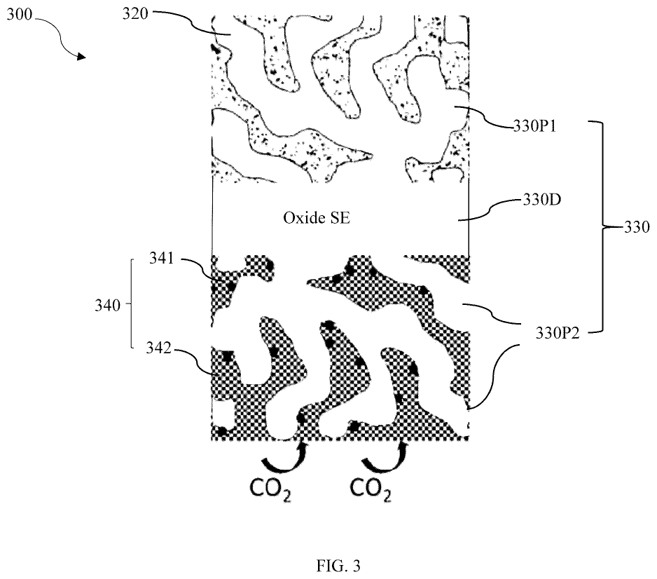

FIG. 3 illustrates a high temperature solid-state Li alloy-CO₂ electrochemical cell where the solid electrolyte has a tri-layer structure. In particular, the solid electrolyte (330) in the electrochemical cell (300) has a dense layer (330D) disposed between a first porous layer (330P1) and a second porous layer (330P2). A negative electrode (320) is disposed inside a plurality of pores of the first porous layer (330P1) and a CO₂ electrode (340) is disposed inside a plurality of pores of the second porous layer (330P2), where the CO₂ electrode (340) comprises a catalyst (341) and an electron conducting material (342).

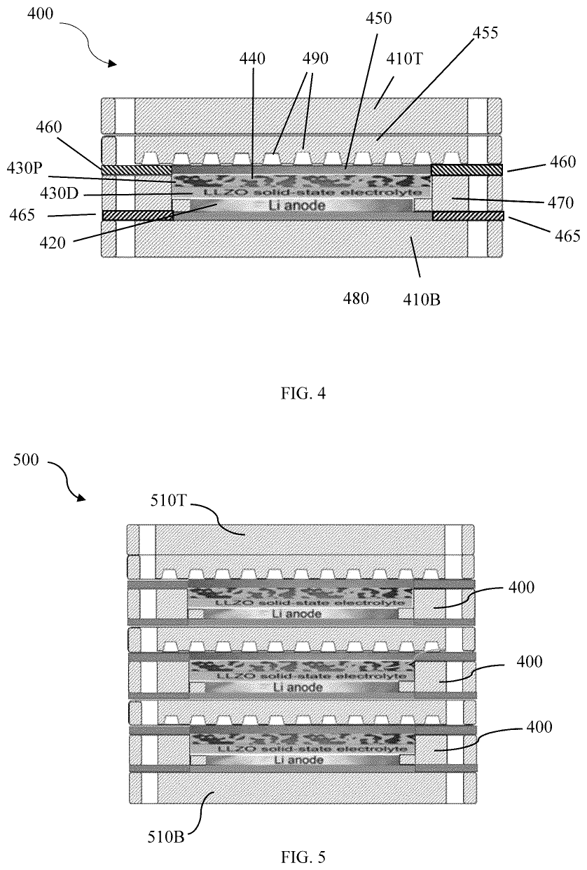

An assembled high temperature solid-state Li alloy-CO₂ electrochemical cell may include a variety of designs, depending on the particular desired use. In a non-limiting exemplary embodiment of an assembled high temperature solid-state Li alloy-CO₂ cell, a negative electrode current collector may be disposed onto a metal end plate. A CO₂ electrode, a solid electrolyte, and a negative electrode may be disposed within a metal core-plate. For example, the core-plate can have a groove, and the solid electrolyte can be bonded on the groove of the core-plate via an adhesive such as CERAMABOND™. The metal core-plate, in turn, is disposed onto the end plate/negative electrode current collector assembly such that the negative electrode current collector is in direct contact with the negative electrode. A CO₂ current collector can be disposed onto a metal plate containing a plurality of passages configured for the flow of a CO₂ gas. The metal plate and CO₂ electrode current collector can be disposed onto the metal core-plate such that the CO₂ electrode current collector makes direct contact with the CO₂ electrode if present as a standalone layer or makes direct contact with a porous solid electrolyte layer if the CO₂ electrode is disposed within the pores of a porous solid electrolyte layer. Gaskets can be used to seal the cell. The material for the gaskets can include ceramics. High temperature gaskets such as those commercially available as THERMICULITE™ or MICA™ may be used. The material for the various metal plates in the cell can include a stainless steel such as a ferrite stainless steel (e.g. SS 410, SS 430, or SS 455) as its thermal expansion coefficient (TEC) is close to the TEC of the oxide solid electrolyte with a TEC difference within 20% or 10%. A single cell and a three-cell stack are shown in FIG. 4 and FIG. 5 respectively.

In FIG. 4, an electrochemical cell (400) includes a solid electrolyte having a dense layer (430D) and a porous layer (430P), a negative electrode (420) disposed on the dense solid electrolyte layer (430D), and a CO₂ electrode (440) disposed inside pores of the porous solid electrolyte layer (430P). The negative electrode (420), the CO₂ electrode (440), and the solid electrode layer (430D+430P) are disposed within the core-plate (470). A bipolar plate (455) with gas flow channels (490) is disposed on the top of the core-plate (470). First gaskets (460) provide a seal between the bipolar plate (455) and the core-plate (470). Further, a top end plate (410T) is placed on the bipolar plate (455), while a bottom end plate (410B) is disposed on the surface of the core-plate (470) opposite that of the bipolar plate (455). Second gaskets (465) provide a seal between the end plate (410B) and the core-plate (470). The negative electrode (420) faces the end plate (410B), while the CO₂ electrode (440) and the porous solid electrolyte layer (430P) face the bipolar plate (455) and the gas flow channels (490). A negative electrode current collector (480) is disposed on and in direct physical contact with the negative electrode (420), whereas a CO₂ electrode current collector (450) is disposed on and in direct contact with the porous solid electrolyte layer (430P).

The electrochemical cell stack can be assembled as a series of two or more cells. Shown in FIG. 5 is a stack (500) of three electrochemical cells (400) between a top end plate (510T) and a bottom end plate (510B).

The high temperature solid-state Li alloy-CO₂ electrochemical cell as described herein can have a unique electrochemical pathway during charge and discharge when operated at a high temperature in the presence of CO₂.

Without wishing to be bound by theory, a discharge reaction for a traditional Li metal-CO₂ battery is believed to be 4Li+3CO₂→2Li₂CO₃+C, 2.9V, with a theoretical specific capacity of 812 mAh/g as per CO₂ weight. Also without wishing to be bound by theory, it is widely believed that the insulated Li₂CO₃ product can lead to low achievable capacity and irreversibility, with actual capacities in most of the conventional Li—CO₂ batteries reported to be less than 2 mAh/cm².

The inventor has surprisingly discovered that the solid-state Li alloy-CO₂ electrochemical cell as disclosed herein has a different reaction mechanism at a high temperature. The different reaction mechanism can completely realize the 4-electron CO₂ reduction reaction, which is surprisingly reversible and exhibits low polarization.

During a discharge cycle, the cell is configured to produce carbon and lithium oxide (Li₂O), and during a charge cycle, the cell can produce lithium and CO₂, when operated at a temperature of 300° C. to 600° C. in the presence of CO₂. The reactions during discharge and charge can be illustrated as follows:

$$Discharge : L i + C {O}_{2} = > {Li}_{2} O + C$$

$$Charge : L {i}_{2} O + C = > Li + C {O}_{2} ,$$

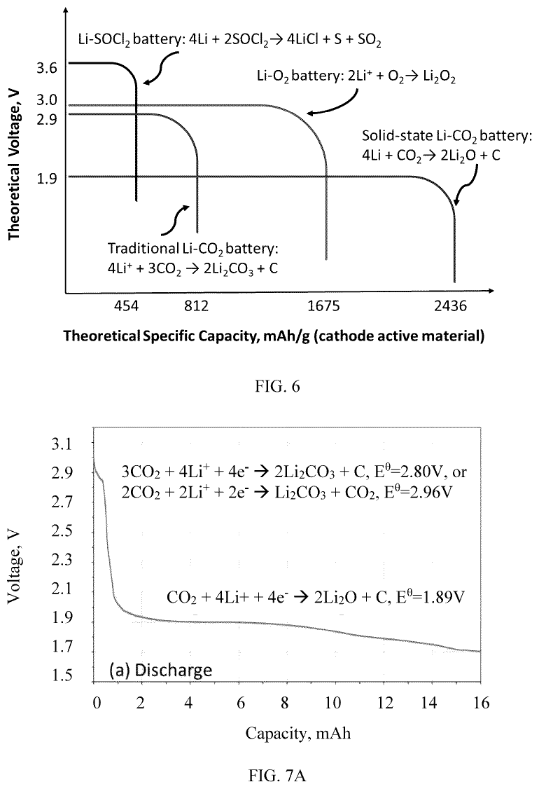

The new reaction can occur at a lower discharge voltage of around 1.9V, and have an extremely high theoretical specific capacity of around 2436 mAh/g as shown in FIG. 6. The theoretical density of the solid-state Li alloy-CO₂ electrochemical cell as described herein is around 4.6 kWh/kg, which is close to the energy density of LiO₂ batteries (5.2 KWh/kg) and is nearly double that of traditional LiCO₂ batteries (2.3 kWh/kg).

The high temperature solid-state Li alloy-CO₂ electrochemical cell of the disclosure can have excellent areal capacity. For example, the cell can have an areal capacity of at least 20 mAh/cm² and up to 200 mAh/cm², or 25 mAh/cm² to 200 mAh/cm² at 300° C. to 600° C. The cell can have a discharge voltage between 3.0 volts and 0.5 volts, or between 2.5 volts and 1.0 volt.

The high temperature solid-state Li alloy-CO₂ electrochemical cell of the disclosure is durable at high temperatures. The durability of the cell can be demonstrated by continuously discharging a cell. As illustrated in the examples, the cell of the disclosure can deliver a very durable performance for over 200 hours or over 250 hours when operated at a high temperature of 500° C. The cell can have a combination of the properties as described herein.

The high temperature solid-state Li alloy-CO₂ electrochemical cell or a stack thereof can be incorporated into various device to provide power to the device. The device may include spacecraft, roving vehicles, communications equipment, robotic arms, and the like.

### Method of Use

The high temperature solid-state Li alloy-CO₂ electrochemical cell as described herein can be used by exposing the cell to a CO₂ gas having a temperature of 300° C. to 600° C. A content of the CO₂ in the CO₂ gas can be greater than 90%, or greater than 95%.

In an aspect, the high temperature solid-state Li alloy-CO₂ electrochemical cell can be exposed to an ambient environment which includes a carbon dioxide gas having a temperature of 300° C. to 600° C. and optionally at a pressure of 1 atm to 100 atm. The cell and a device comprising the cell or a stack thereof can be used on Venus surface taking advantage of the readily available ambient CO₂ gas.

The high temperature electrochemical cell of the disclosure is further illustrated by the following non-limiting examples.

### EXAMPLES

### Negative Electrode

### Pure Lithium Foil (Comparative Example)

As a comparative example, a pure lithium foil (0.75 mm thickness, Sigma-Aldrich) was punched as 1 inch diameter disk and used as a negative electrode in Li metal-CO₂ cells having lithium lanthanum zirconium oxide, optionally doped with Ta, Nb, or a combination thereof (LLZO) pellets as the solid-electrolyte layer. Since the melting point of pure lithium is 180° C., the pure lithium foil became a liquid when the cells were heated up from room temperature to the testing high temperatures (300° C., 400° C. and 500° C.). Optical microscopy analysis indicates that molten lithium can have good wettability with LLZO pellets. However, the LLZO pellets tend to crack when temperature is increased to 500° C. Without wishing to be bound by theory, it is believed that the crack may be caused by the stress originated from the reaction between molten lithium and LLZO. It was also found that molten lithium can react with ceramic binder (CERAMABOND™ 552, Aremco Products Inc.) used to seal the cells. In addition, lithium crossover from the negative electrode side to the CO₂ electrode side was observed.

### LiAl Alloys

LiAl alloy powders (Sigma Aldrich) were pressed to form disks having a diameter of 1 inch and a thickness of 200 μm using a die inside an argon-filled glove box. The discs were used as negative electrodes in Li alloy-CO₂ cells with LLZO pellets as the solid electrolyte. LiAl alloys have melting points above 500° C. and can address the issues of pure lithium when the cells are operated at high temperatures. It was found that a thin layer of pure lithium with a thickness of less than 50 μm can be used as an interlayer between the LiAl alloy discs and the LLZO solid electrolyte to improve the wettability of the LiAl alloy, thus reducing the interface impedance between the negative electrode and the solid electrolyte.

### LiB Alloys

Lithium boron (LiB) alloys were also used as negative electrodes. A series of lithium-rich LiB alloys (70 wt %, 75 wt %, 80 wt %, 85 wt %, and 90 wt % Li) were prepared by adding boron powders into a molten lithium in a box furnace inside an argon-filled glove box. The mixtures were heated up above their corresponding melting points and stirred for 4 hours to complete the alloying. As shown in the table below, the LiB alloys have much higher capacity than LiAl alloys, with no voltage penalty. The interface wettability between the lithium alloys and the solid electrolyte in the cells is also good due to the high lithium content.

| Negative | | | Specific Capacity | Voltage (v) | Melting Point |
|---|---|---|---|---|---|
| Electrode | Li atomic % | Li wt % | mAh/g | vs Li/Li+ | (° C.) |
| Li | 100 | 100 | 3860 | 0 | 180 |
| LiAl alloy 1 | 50 | 21 | 794 | 0.3 | 702 |
| LiAl alloy 2 | 70 | 38 | 1455 | 0.3 | 580 |
| LiB alloy 1 | 54 | 43 | 1660 | 0.4 | >1000 |
| LiB alloy 2 | 79 | 70 | 1842 | 0 | 820 |
| LiB alloy 3 | 86 | 80 | 2519 | 0 | 800 |
| LiB alloy 4 | 93 | 90 | 3188 | 0 | 760 |

### Solid-State Electrolyte

### Mono-Layer Structure

LLZO powders (500 nm particle size, MTI Corp.) were pressed into dense pellets (green samples, diameter 1.5 cm, 3.0 cm or 10 cm, thickness from 0.5 mm to 2 mm) with a die. Green samples were covered by some LLZO powders (mother powders) then sintered at 1200° C. for 10 hours. The final LLZO solid electrolyte (dense solid electrolyte layer), after a size contraction about 20-30% of the green samples, had diameters of around 1.2 cm, 2.3 cm, or 7.5 cm, respectively. The thickness of the LLZO solid electrolyte layer was controlled to be 0.4 mm to 1.6 mm.

### Bi-Layer Structure

To create an ionic conducting matrix for the CO₂ electrode, a porous LLZO layer was simultaneously formed together with a dense LLZO layer. A LLZO powder was first added to a die container. A stainless-steel post was used to flat the surface of the powder. Then a mixture of LLZO and graphite (SAG-R, MTI) was added into the die container. Graphite was used as a pore-forming agent to produce the porous layer. The weight percent of LLZO and graphite was adjusted from 80%: 20% to 20%: 80% for a theoretical porosity of 40% to 90% for different bi-layer structures. After pressed at a high pressure (20-24 metric tons), the green sample was sintered in a tube furnace at 700° C. for 2 hours, then at 1200° C. for 10 hours under an oxygen flow of 100 ml/min. The final bi-layer LLZO solid electrolyte has a dense layer (thickness around 1 mm) and a porous layer (thickness around 0.2-0.5 mm).

### Tri-Layer Structure

A solid electrolyte having a tri-layer structure was fabricated with a method similar to the method to make a bi-layer structure. A mixture of LLZO and graphite was first set up in a die container, followed by a layer of LLZO powder and another layer of LLZO/graphite mixture. The powders were pressed to form a green sample, which was sintered under similar conditions for forming bi-layer structures. The final tri-layer LLZO solid electrolyte had a dense layer (thickness around 1 mm) and two porous layers (thickness around 0.2-0.5 mm) disposed on opposite surfaces of the dense layer.

### CO₂ Reduction Catalysts

### Gold Nanoparticles

A chemical reduction route, the Turkevich method, was used to prepare Au nanoparticles. In the Turkevich method, L-ascorbic acid was used to reduce Au precursors to metallic Au, while polyvinyl pyrrolidine was used to control the size of the particles. In the presence of ethanol and water mixture, the pH value of the reducing solution was controlled to be about 10.5 by adding a solution of 2M NaOH. Then, a 5 mM HAuCl₄ (Sigma Aldrich) solution was quickly injected into the reducing mixture, and Au nanoparticles were formed under vigorously stirring. The resulting nanoparticles had an average particle size of 9 nm as measured by SEM.

### Silver Nanoparticles

Silver nanoparticles were prepared with a method similar to the method of making Au nanoparticles, except that a AgNO₃ solution was used instead of a HAuCl₄ solution.

In another method, silver conducting paste (200 nm of 80%, <5 nm of 20%, Sigma Aldrich) was used as a source of Ag nanoparticles. The catalyst was formed by directly burning off the polymer binder in the paste.

### Carbon Nanotube Supported Au Catalyst

Carbon nanotube supported Au (Au/C) catalysts were prepared by adding carbon nanotube (Sigma Aldrich) into a reaction mixture containing Au nanoparticles, and filtering the mixture after Au nanoparticles were deposited on the carbon nanotube. A catalyst (Au/C) with 20 wt % of Au was prepared by controlling the material weights.

### CO₂ Electrode

### Stand-Alone CO₂ Electrode on the Dense Solid Electrolyte Layer

A LLZO powder, a graphite powder, and a silver paste (weight ratio is 1:1:1) were mixed with a SPEX mixer to form a paste. Ethanol was used to adjust the viscosity of the paste. The paste was coated on one side of a mono-layer LLZO solid electrolyte, with a thickness from 0.1 to 1 mm according to the CO₂ electrode capacity design. The coated sample was sintered in a tube furnace in air at 900° C. (5° C./min heat rate) for 2 hours, in order to burn off graphite and polymer binder (in silver paste) to create a porous structure for gas diffusion, and to bond the LLZO in the porous structure to the LLZO dense solid electrolyte layer to reduce the interfacial impedance. Ag or Au nanoparticles suspended in ethanol were deposited into the pores of the porous structure after ethanol evaporation to form a LLZO—Ag based CO₂ electrode. The CO₂ electrode can be disposed on a dense LLZO solid electrolyte layer.

A lithium cobalt oxide (LCO)—Ag based CO₂ electrode was made using the above-described procedure by replacing the LLZO powder with a LCO powder.

A lanthanum strontium cobalt iron oxide (LSCF)—Ag based CO₂ electrode was prepared using the above-described procedure by replacing the LLZO powder with a LSCF powder.

### CO₂ Electrode Disposed Inside Pores of a Porous Solid Electrolyte Layer

Ag or Au nanoparticles suspended in ethanol were deposited into a porous solid electrolyte layer of a bi-layer or tri-layer solid electrolyte, followed by ethanol evaporation in a vacuum oven.

### Li—CO₂ Single Cell Fabrication and Testing

### Cell Fabrication—General Procedure

A Li alloy-CO₂ single cell was made by bonding a LLZO dense layer to a core-plate with a CERAMABOND™ paste (cured at 230° C. for 4 hours after naturally drying overnight). A copper foam (negative electrode current collector), a lithium alloy disc, a CO₂ electrode (e.g., LLZO—Ag based electrode), a silver foam (CO₂ electrode current collector), and a gas flow channel plate, two stainless steel end plates, and MICA™ sealant sheets were assembled as described herein in the context of FIG. 4. The cell was sealed with a tightening torque of 40 inch-pounds, secured by four sets of bolts and nuts.

### Testing

The cells were tested inside a box furnace with CO₂ gas flow (100 mL/min) at 500° C. (heat up at 2° C./min). A battery charger (10 mA 5V, 8-channel, LAND) was used for discharge-charge test. A potentiostat (Interface-1010e, Gamry) was used to measure AC (alternating current) impedance and also charge-discharge test for cell stacks with high voltages.

### Cell Example 1

A Li alloy-CO₂ single cell including a LiAl alloy negative electrode (with a thin Li interlayer), a LLZO—Ag based CO₂ electrode (0.2 mm thick, with Au nanoparticle catalysts) and a dense LLZO layer (1 mm thick) was made.

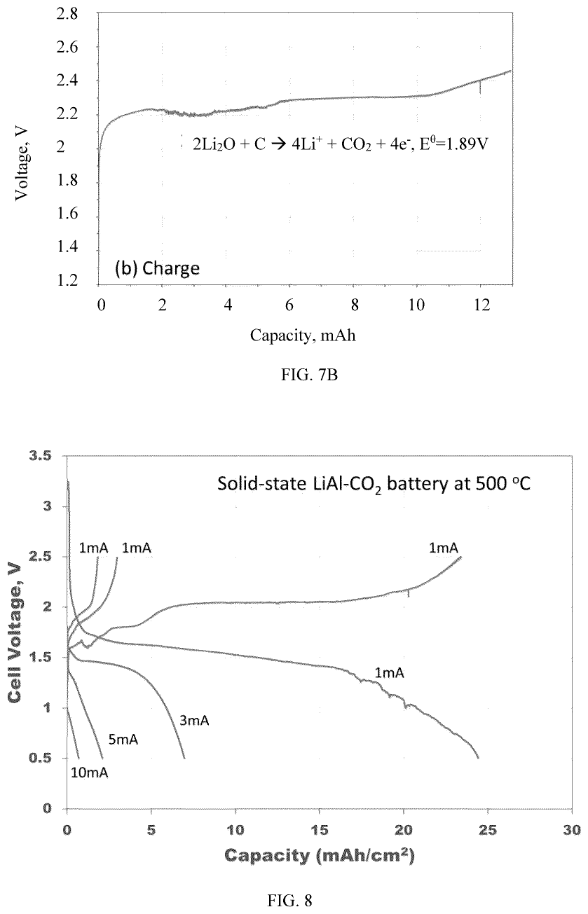

The cell was discharged from open circuit voltage (OCV) (3.0 V) to 1.0 V and charged from 1.0 V to 2.5 V at 0.5 mA and 500° C. As shown in FIG. 7A, the discharge curve showed a two-step process, where CO₂ was first reduced to Li₂CO₃ and C around 2.8 V for a capacity less than 1 mAh, and then reduced to Li₂O and C around 1.89 V for a capacity more than 20 mAh. As shown in FIG. 7B, the charge curve had a voltage plateau average of 2.3 V, which is believed to be a reverse reaction of the second discharge reaction.

### Cell Example 2

A Li alloy-CO₂ single cell including a LiAl alloy negative electrode (with a thin Li interlayer), a LLZO—Ag based CO₂ electrode (0.2 mm thick, with Au/C catalysts) and a dense LLZO layer (1 mm thick) was made.

At 500° C., the cell was discharged to 0.5V at 1 mA, then charged to 2.5 V at 1 mA, then discharged again to 0.5 V at 3 mA, then charged again to 2.5V at 1 mA, then discharged again to 0.5 V at 5 mA, then charged again to 2.5 V at 1 mA, and then discharged again to 0.5 V at 10 mA. The results are shown in FIG. 8. At the first discharge, the cell delivered a capacity as high as 24.5 mAh/cm². The average charge-discharge voltage gap was less than 0.5 V, indicating good reversibility. The cell was able to work even if the current increased to 10 mA.

### Cell Example 3

A Li alloy-CO₂ single cell including a LiAl alloy negative electrode (with a thin Li interlayer), a LLZO—Ag based CO₂ electrode (0.2 mm thick, with Au/C catalysts) and a dense LLZO layer (1 mm thick) was made.

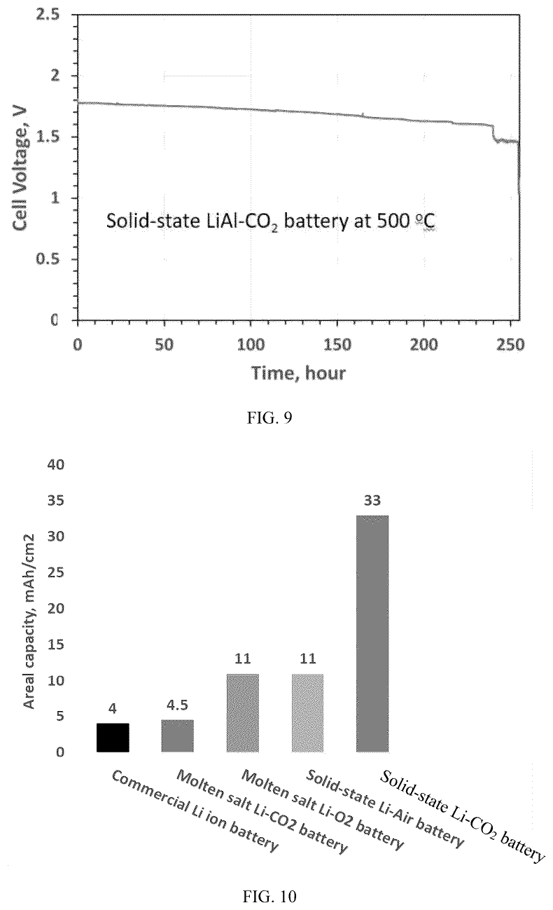

At 500° C., the cell was discharged to 1.0 V at a low current rate of 0.1 mA (equal to 0.13 mA/cm²). As shown in FIG. 9 and FIG. 10, the cell lasted for 255 hours, with a high areal capacity of 33 mAh/cm², which is much higher than the reported areal capacities of known batteries.

### Cell Example 4

A Li alloy-CO₂ single cell including a LiAl alloy negative electrode (with a thin Li interlayer), a LCO—Ag based CO₂ electrode (0.2 mm thick) and a dense LLZO layer (1 mm thick) was made.

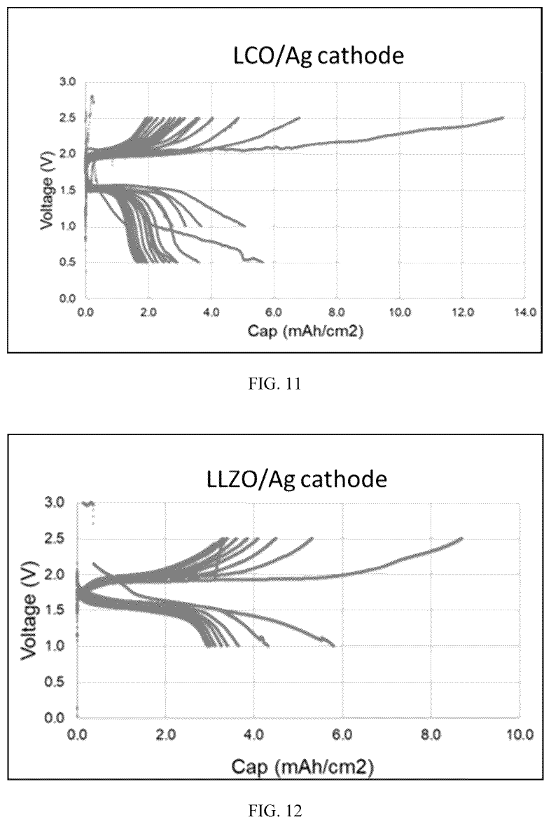

At 500° C., the cell was continuously charged and discharged for over 110 hours with 20 cycles between 0.5 V and 2.5 V as shown in FIG. 11.

### Cell Example 5

A Li alloy-CO₂ single cell including a LiAl alloy negative electrode (with a thin Li interlayer), a LLZO—Ag based CO₂ electrode (0.2 mm thick) and a dense LLZO solid electrolyte layer (1 mm thick) was made.

At 500° C., the cell was continuously charged and discharged for more than 70 hours over 10 cycles between 1.0 V and 2.5 V as shown in FIG. 12.

### Cell Example 6

A Li alloy-CO₂ single cell including a LiB alloy negative electrode (85 wt % Li), a LLZO—Ag based CO₂ electrode (0.5 mm thick, with Au/C catalysts) and a dense LLZO solid electrolyte layer (1 mm thick) was made.

At 500° C., the cell was discharged to 0.5 V at a current rate of 3 mA (equal to 1.7 mA/cm²). The cell lasted for 105 hours, with an excellent areal capacity of 60 mAh/cm².

### Li Alloy-CO₂ Cell Stack Fabrication and Testing

A Li alloy-CO₂ cell stack was built up by integrating multiple single cells using either a series method, a parallel method, or a combination of both. The gas flow plates in the single cells were designed as a bipolar plate to interconnect the single cells.

### Cell Stack 1

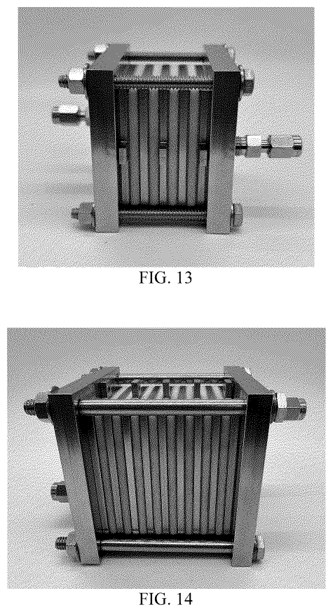

A four-cell Li alloy-CO₂ cell stack as shown in FIG. 13 was fabricated by a series integration of four single cells, using four bipolar plates. The battery had an open circuit voltage of 12V.

### Cell Stack 2

An eight-cell Li—CO₂ cell stack as shown in FIG. 14 was fabricated by a series integration of eight single cells, using eight bipolar plates. The battery had an open circuit voltage of 24 V.

This disclosure further encompasses the following aspects.

Aspect 1. A high temperature solid-state lithium alloy-carbon dioxide electrochemical cell comprising: a negative electrode comprising a lithium alloy having a melting point greater than 500° C.; a carbon dioxide electrode comprising a catalyst effective to reduce carbon dioxide at a temperature of 300° C. to 600° C. during discharge of the electrochemical cell; and a solid electrolyte comprising an oxide solid electrolyte and having a dense layer that separates the negative electrode and the carbon dioxide electrode, the dense layer having a porosity of less than 2 percent based on a total volume of the dense layer.

Aspect 2. The high temperature solid-state lithium alloy-carbon dioxide electrochemical cell of aspect 1, wherein the high temperature solid-state lithium alloy-carbon dioxide electrochemical cell: (1) has a carbon dioxide electrode having an areal capacity of 20 mAh/cm² to 200 mAh/cm²; (2) has a discharge voltage between 3.0 volts and 0.5 volts; (3) is configured to produce carbon and lithium oxide at a temperature of 300° C. to 600° C. during a discharge cycle and to produce lithium and carbon dioxide during a charge cycle; (4) is rechargeable; or a combination thereof.

Aspect 3. The high temperature solid-state lithium alloy-carbon dioxide electrochemical cell of any of the preceding aspects, wherein the carbon dioxide electrode further comprises a carbon dioxide gas having a temperature of 300° C. to 600° C.

Aspect 4. The high temperature solid-state lithium alloy-carbon dioxide electrochemical cell of aspect 3, wherein the carbon dioxide gas comprises greater than 90 weight percent of carbon dioxide based on a total weight of the carbon dioxide gas.

Aspect 5. The high temperature solid-state lithium alloy-carbon dioxide electrochemical cell of any of the preceding aspects, wherein the catalyst in the carbon dioxide electrode comprises Au, Ag, Ir, Ru, or a combination thereof.

Aspect 6. The high temperature solid-state lithium alloy-carbon dioxide electrochemical cell of any of the preceding aspects, wherein the catalyst in the carbon dioxide electrode comprises nanoparticles of Au, Ag, Ir, Ru, or a combination thereof, and the nanoparticles have an average particle size of 5 nanometers to 200 nanometers.

Aspect 7. The high temperature solid-state lithium alloy-carbon dioxide electrochemical cell of any of the preceding aspects, wherein the carbon dioxide electrode further comprises an electron conducting material, and optionally an ion conducting material.

Aspect 8. The high temperature solid-state lithium alloy-carbon dioxide electrochemical cell of any of the preceding aspects, wherein the carbon dioxide electrode has a porosity of 40 to 80 percent based on a total volume of the carbon dioxide electrode.

Aspect 9. The high temperature solid-state lithium alloy-carbon dioxide electrochemical cell of any of the preceding aspects, wherein the lithium alloy comprises a lithium aluminum alloy, a lithium boron alloy, a lithium silicon alloy, or a combination thereof.

Aspect 10. The high temperature solid-state lithium alloy-carbon dioxide electrochemical cell of any of the preceding aspects, wherein the lithium alloy comprises a lithium boron alloy or a lithium silicon alloy, the lithium boron alloy or lithium silicon alloy comprises 20 weight percent to 90 weight percent of lithium based on a total weight of the lithium alloy.

Aspect 11. The high temperature solid-state lithium alloy-carbon dioxide electrochemical cell of any of the preceding aspects, wherein the oxide solid electrolyte has a garnet structure.

Aspect 12. The high temperature solid-state lithium alloy-carbon dioxide electrochemical cell of any of the preceding aspects, wherein the oxide solid electrolyte has a composition represented by Li₅₊ₓLa₃ZrₓM₂₋ₓO₁₂, wherein x is 1.5 to 2, and M is Ta, Nb, or a combination thereof.

Aspect 13. The high temperature solid-state lithium alloy-carbon dioxide electrochemical cell of any of the preceding aspects, wherein the solid electrolyte consists of the dense layer with a first surface and an opposite second surface; the dense layer has a thickness of 100 μm to 1,500 μm; the negative electrode comprises a layer of the lithium alloy and is disposed on the first surface of the dense layer; and the carbon dioxide electrode is a layer comprising the catalyst, and an ionic-electronic conducting material and is disposed on the second surface of the dense layer.

Aspect 14. The high temperature solid-state lithium alloy-carbon dioxide electrochemical cell of aspect 13, wherein the ionic-electronic conducting material comprises lithium lanthanum zirconium oxide; a lithium lanthanum zirconium oxide doped with Ta, Nb, or a combination thereof; lithium cobalt oxide; lanthanum strontium cobalt ferrite; an eutectic molten salt of lithium-sodium-potassium; carbon nanotube; silver paste; silver foam; or a combination thereof.

Aspect 15. The high temperature solid-state lithium alloy-carbon dioxide electrochemical cell of aspect 13 or aspect 14, wherein a content of the catalyst in the carbon dioxide electrode is 2 to 30 wt %, based on a total weight of the catalyst and the ionic-electronic conducting material.

Aspect 16. The high temperature solid-state lithium alloy-carbon dioxide electrochemical cell of any of aspects 13 to 15, further comprising a current collector disposed on the carbon dioxide electrode, and the current collector is a silver or gold mesh, or a silver or gold foam.

Aspect 17. The high temperature solid-state lithium alloy-carbon dioxide electrochemical cell of any of aspects 1 to 12, wherein the solid electrolyte has a two-layer structure comprising the dense layer and a porous layer disposed on the dense layer; the dense layer has a thickness of 100 μm to 500 μm; the porous layer has a thickness of 500 μm to 1,000 μm and a porosity of 40 percent to 80 percent based on a total volume of the porous layer; the negative electrode comprises a layer of the lithium alloy and is disposed on a surface of the dense layer; and the carbon dioxide electrode is disposed inside a plurality of pores of the porous layer and comprises the catalyst and optionally an electron conducting material.

Aspect 18. The high temperature solid-state lithium alloy-carbon dioxide electrochemical cell of any of aspects 1 to 12, wherein the solid electrolyte has a tri-layer structure with the dense layer disposed between a first porous layer and a second porous layer; the dense layer has a thickness of 100 μm to 500 μm; the first porous layer and the second porous layer each independently has a thickness of 500 μm to 1,000 μm and a porosity of 40 percent to 80 percent, each based on a total volume of the respective first porous layer or the second porous layer; the negative electrode is disposed inside a plurality of pores of the first porous layer; and the carbon dioxide electrode is disposed inside a plurality of pores of the second porous layer and comprises the catalyst and optionally an electron conducting material.

Aspect 19. The high temperature solid-state lithium alloy-carbon dioxide electrochemical cell of any of aspects 17 to 18, wherein the carbon dioxide electrode comprises the electron conducting material, and the electron conducting material comprises carbon nanotube; silver foam; lithium cobalt oxide; lanthanum strontium cobalt ferrite; or a combination thereof.

Aspect 20. A device comprising at least one of the high temperature solid-state lithium alloy-carbon dioxide electrochemical cell of any of the preceding aspects or a stack thereof.

Aspect 21. A method comprising providing the high temperature solid-state lithium alloy-carbon dioxide electrochemical cell of any of the preceding claims or a stack thereof, and contacting the solid-state lithium alloy-carbon dioxide electrochemical cell or the stack thereof with a carbon dioxide gas having a temperature of 300° C. to 600° C.

Aspect 22. A method comprising providing the high temperature solid-state lithium alloy-carbon dioxide electrochemical cell of any of the preceding claims or a stack thereof, and exposing the solid-state lithium alloy-carbon dioxide electrochemical cell or the stack thereof to an ambient environment which includes a carbon dioxide gas having a temperature of 300° C. to 600° C. and a pressure of 1 atm to 100 atm.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function or objectives of the compositions, methods, and articles.

The singular forms “a,” “an,” and “the” include plural referents unless the context clearly dictates otherwise. “Or” means “and/or” unless clearly indicated otherwise by context. The modifier “about” used in connection with a quantity is inclusive of the stated value (e.g., “about 25-50 wt %” is a disclosure of “25-50 wt. %”) and has the meaning dictated by the context (e.g., includes the degree of error associated with measurement of the particular quantity). Unless expressly stated otherwise, all ranges used herein include endpoints, and the endpoints may be combined independently. “Optional” or “optionally” means that the subsequently described event or circumstance can or cannot occur, and that the description includes instances where the event occurs and instances where it does not. A “combination” is inclusive of blends, mixtures, alloys, reaction products, and the like. The terms “first,” “second,” and the like, do not denote any order, quantity, or importance, but rather are used to distinguish one element from another.

The term “ambient” or “ambient environment” refers to the immediate surroundings of an object or substance. For example, “ambient environment” in relation to a Li alloy-CO₂ electrochemical cell may refer to the atmospheric environment that surrounds the electrochemical cell, and “ambient temperature” may refer to the temperature of the environment surrounding the Li alloy-CO₂ battery.

If a term in the present application contradicts or conflicts with a term in an incorporated reference, the term from the present application takes precedence over the conflicting term from the incorporated reference.

While embodiments have been set forth for the purpose of illustration, the foregoing descriptions should not be deemed a limitation on the scope herein. Accordingly, various modifications, adaptations, and alternatives can occur to one skilled in the art without departing from the spirit and scope herein.

What is claimed is:

1. A high temperature solid-state lithium alloy-carbon dioxide electrochemical cell comprising:
a negative electrode comprising a lithium alloy having a melting point greater than 500° C.;
a carbon dioxide electrode comprising a catalyst effective to reduce carbon dioxide at a temperature of 300° C. to 600° C. during discharge of the electrochemical cell; and
a solid electrolyte comprising an oxide solid electrolyte and having a dense layer that separates the negative electrode and the carbon dioxide electrode, the dense layer having a porosity of less than 2 percent based on a total volume of the dense layer.

2. The high temperature solid-state lithium alloy-carbon dioxide electrochemical cell of claim 1, wherein the high temperature solid-state lithium alloy-carbon dioxide electrochemical cell:
(1) has a carbon dioxide electrode having an areal capacity of 20 mAh/cm² to 200 mAh/cm²;
(2) has a discharge voltage between 3.0 volts and 0.5 volts;
(3) is configured to produce carbon and lithium oxide at a temperature of 300° C. to 600° C. during a discharge cycle and to produce lithium and carbon dioxide during a charge cycle;
(4) is rechargeable;
or a combination thereof.

3. The high temperature solid-state lithium alloy-carbon dioxide electrochemical cell of claim 1, wherein the carbon dioxide electrode further comprises a carbon dioxide gas having a temperature of 300° C. to 600° C.

4. The high temperature solid-state lithium alloy-carbon dioxide electrochemical cell of claim 3, wherein the carbon dioxide gas comprises greater than 90 weight percent of carbon dioxide based on a total weight of the carbon dioxide gas.

5. The high temperature solid-state lithium alloy-carbon dioxide electrochemical cell of claim 1, wherein the catalyst in the carbon dioxide electrode comprises Au, Ag, Ir, Ru, or a combination thereof.

6. The high temperature solid-state lithium alloy-carbon dioxide electrochemical cell of claim 5, wherein the catalyst in the carbon dioxide electrode comprises nanoparticles of Au, Ag, Ir, Ru, or a combination thereof, and the nanoparticles have an average particle size of 5 nanometers to 200 nanometers.

7. The high temperature solid-state lithium alloy-carbon dioxide electrochemical cell of claim 1, wherein the carbon dioxide electrode further comprises an electron conducting material, and optionally an ion conducting material.

8. The high temperature solid-state lithium alloy-carbon dioxide electrochemical cell of claim 1, wherein the carbon dioxide electrode has a porosity of 40 to 80 percent based on a total volume of the carbon dioxide electrode.

9. The high temperature solid-state lithium alloy-carbon dioxide electrochemical cell of claim 1, wherein the lithium alloy comprises a lithium aluminum alloy, a lithium boron alloy, a lithium silicon alloy, or a combination thereof.

10. The high temperature solid-state lithium alloy-carbon dioxide electrochemical cell of claim 1, wherein the lithium alloy comprises a lithium boron alloy or a lithium silicon alloy, the lithium boron alloy or lithium silicon alloy comprises 20 weight percent to 90 weight percent of lithium based on a total weight of the lithium alloy.

11. The high temperature solid-state lithium alloy-carbon dioxide electrochemical cell of claim 1, wherein the oxide solid electrolyte has a garnet structure.

12. The high temperature solid-state lithium alloy-carbon dioxide electrochemical cell of claim 1, wherein the oxide solid electrolyte has a composition represented by Li₅₊ₓLa₃ZrₓM₂₋ₓO₁₂, wherein x is 1.5 to 2, and M is Ta, Nb, or a combination thereof.

13. The high temperature solid-state lithium alloy-carbon dioxide electrochemical cell of claim 1, wherein
the solid electrolyte consists of the dense layer with a first surface and an opposite second surface;
the dense layer has a thickness of 100 μm to 1,500 μm;
the negative electrode comprises a layer of the lithium alloy and is disposed on the first surface of the dense layer; and
the carbon dioxide electrode is a layer comprising the catalyst, and an ionic-electronic conducting material and is disposed on the second surface of the dense layer.

14. The high temperature solid-state lithium alloy-carbon dioxide electrochemical cell of claim 13, wherein the ionic-electronic conducting material comprises lithium lanthanum zirconium oxide; a lithium lanthanum zirconium oxide doped with Ta, Nb, or a combination thereof; lithium cobalt oxide; lanthanum strontium cobalt ferrite; an eutectic molten salt of lithium-sodium-potassium; carbon nanotube; silver paste; silver foam; or a combination thereof.

15. The high temperature solid-state lithium alloy-carbon dioxide electrochemical cell of claim 13, wherein a content of the catalyst in the carbon dioxide electrode is 2 to 30 wt %, based on a total weight of the catalyst and the ionic-electronic conducting material.

16. The high temperature solid-state lithium alloy-carbon dioxide electrochemical cell of claim 13, further comprising a current collector disposed on the carbon dioxide electrode, and the current collector is a silver or gold mesh, or a silver or gold foam.

17. The high temperature solid-state lithium alloy-carbon dioxide electrochemical cell of claim 1, wherein
the solid electrolyte has a two-layer structure comprising the dense layer and a porous layer disposed on the dense layer;
the dense layer has a thickness of 100 μm to 500 μm;
the porous layer has a thickness of 500 μm to 1,000 μm and a porosity of 40 percent to 80 percent based on a total volume of the porous layer;
the negative electrode comprises a layer of the lithium alloy and is disposed on a surface of the dense layer; and
the carbon dioxide electrode is disposed inside a plurality of pores of the porous layer and comprises the catalyst and optionally an electron conducting material.

18. The high temperature solid-state lithium alloy-carbon dioxide electrochemical cell of claim 17, wherein the carbon dioxide electrode comprises the electron conducting material, and the electron conducting material comprises carbon nanotube; silver foam; lithium cobalt oxide; lanthanum strontium cobalt ferrite; or a combination thereof.

19. The high temperature solid-state lithium alloy-carbon dioxide electrochemical cell of claim 1, wherein
the solid electrolyte has a tri-layer structure with the dense layer disposed between a first porous layer and a second porous layer;
the dense layer has a thickness of 100 μm to 500 μm;
the first porous layer and the second porous layer each independently has a thickness of 500 μm to 1,000 μm and a porosity of 40 percent to 80 percent, each based on a total volume of the respective first porous layer or the second porous layer;
the negative electrode is disposed inside a plurality of pores of the first porous layer; and
the carbon dioxide electrode is disposed inside a plurality of pores of the second porous layer and comprises the catalyst and optionally an electron conducting material.

20. A device comprising at least one of the high temperature solid-state lithium alloy-carbon dioxide electrochemical cell of claim 1 or a stack thereof.

21. A method comprising
providing the high temperature solid-state lithium alloy-carbon dioxide electrochemical cell of claim 1 or a stack thereof, and
contacting the solid-state lithium alloy-carbon dioxide electrochemical cell or the stack thereof with a carbon dioxide gas having a temperature of 300° C. to 600° C.

22. A method comprising
providing the high temperature solid-state lithium alloy-carbon dioxide electrochemical cell of claim 1 or a stack thereof, and
exposing the solid-state lithium alloy-carbon dioxide electrochemical cell or the stack thereof to an ambient environment which includes a carbon dioxide gas having a temperature of 300° C. to 600° C. and a pressure of 1 atm to 100 atm.
